(19) United States
(12) Patent Application Publication
(10) Pub. No.: US 2025/0344128 A1
(43) Pub. Date: Nov. 6, 2025

(54) DEVICE AND METHOD PERFORMED BY THE DEVICE IN A WIRELESS COMMUNICATION

(71) Applicants: SAMSUNG ELECTRONICS CO., LTD., Suwon-si, Gyeonggi-do (KR); BEIJING SAMSUNG TELECOM R&D CENTER, Chaoyang district, Beijing (CN)

(72) Inventors: Weiwei WANG, Beijing (CN); Milos TESANOVIC, Staines, Middlesex (GB); Hyunjeong KANG, Suwon-si (KR)

(21) Appl. No.: 19/126,470

(22) PCT Filed: Nov. 2, 2023
(86) PCT No.: PCT/KR2023/017325

§ 371 Date: May 1, 2025

(30) Foreign Application Priority Data
Nov. 2, 2022 (CN) 202211364937.8

(51) Int. Cl. H04W 40/22; H04W 72/25; H04W 88/04

(52) U.S. Cl. CPC H04W 40/22; H04W 72/25; H04W 88/04

(57) ABSTRACT

The disclosure relates to a 5G or 6G communication system for supporting a higher data transmission rate. The disclosure provides a method performed by first user equipment, which comprises: sending a first message to a first network node, the first message is used for informing information related to a type or mode of a first link; receiving a second message sent by the first network node, the second message is used for configuring the first user equipment to perform data transmission with the first network node through the first link between the first user equipment and a second user equipment.

### TECHNICAL FIELD

The disclosure relates to a field of communication, and more specifically, to a method performed by first user equipment, a method performed by a first network node, a method performed by a second network node, first user equipment, a first network node, and a second network node.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Solution to Problem

According to an aspect of the disclosure, there is provided a method performed by first user equipment, which comprises: sending a first message to a first network node, the first message is used for informing information related to a type or mode of a first link; receiving a second message sent by the first network node, the second message is used for configuring the first user equipment to perform data transmission with the first network node through the first link between the first user equipment and a second user equipment.

According to the method performed by the first user equipment provided by the disclosure, the method further comprises establishing the first link with the second user equipment.

According to the method performed by the first user equipment provided by the disclosure, wherein the first message comprises at least one of the followings: first identification indication information for indicating identification information of the first user equipment and/or the second user equipment; first measurement indication information for indicating a measurement result of the first user equipment; or second measurement indication information for indicating a measurement result of the second user equipment.

According to the method performed by the first user equipment provided by the disclosure, wherein the first identification indication information comprises at least one of the followings: first identification information including identification information of the first user equipment; second identification information including identification information of the second user equipment; or third identification information including an identification pair of an identification of the first user equipment and an identification of the second user equipment.

According to the method performed by the first user equipment provided by the disclosure, wherein the first measurement indication information or the second measurement indication information comprises at least one of the followings: association identification information for indicating the measured first user equipment or the second user equipment; measurement result information for indicating a measurement result of the first link by the first user equipment or the second user equipment; or first type or mode information for indicating a type or mode of the first link.

According to the method performed by the first user equipment provided by the disclosure, wherein the measurement result information comprises at least one of the followings: signal strength information; indication information of a signal quality or link quality for indicating a quality of the first link; parameter information of an obtainable quality of service (QoS) for indicating a quality of service that the first user equipment is able to reach on the first link; or priority indication information for indicating a priority of the second user equipment or the first user equipment.

According to the method performed by the first user equipment provided by the disclosure, wherein the first measurement indication information or the second measurement indication information comprises a list composed of at least an association identification information and/or the measurement result information corresponding to the at least an association identification information.

According to the method performed by the first user equipment provided by the disclosure, wherein the priority is determined based on a position of the association identification information corresponding to the user equipment in the association identification information list in the measurement indication information.

According to the method performed by the first user equipment provided by the disclosure, wherein the corresponding user equipment indicated by the association identification information in the list is a node which satisfies a preset condition, or a number of the corresponding user equipment indicated by the association identification information in the list satisfies a predetermined number.

According to the method performed by the first user equipment provided by the disclosure, wherein the second message comprises at least one of the followings: first user equipment identification; a second user equipment identification; or a type or mode of the first link.

According to the method performed by the first user equipment provided by the disclosure, wherein the type of the first link comprises at least one of the followings: a 3rd generation partnership project (3GPP) link; or a non-3GPP link.

According to the method performed by the first user equipment provided by the disclosure, the method further comprises: receiving a third configuration message sent by the first network node, the third configuration message is used for configuring the discovery and/or measurement of nodes on the first link by the first user equipment.

According to the method performed by the first user equipment provided by the disclosure, wherein the third configuration message comprises at least one of the followings: first threshold information for determining threshold information of a candidate second user equipment establishing the first link with the first user equipment; first number information for indicating the maximum number of candidate second user equipment establishing the first link with the first user equipment; first indication information for indicating information of the first user equipment; second indication information for indicating information of the second user equipment; third indication information for indicating one or more first user equipment and/or one or more second user equipment served by the first network node.

According to the method performed by the first user equipment provided by the disclosure, wherein the first indication information comprises at least one of the followings: sixth identification indication information for indicating the identification of the first user equipment; or first bearer information for indicating the bearer required by the first user equipment; and/or wherein the second indication information comprises at least one of the followings: seventh identification indication information for indicating the identification of the second user equipment; or second bearer information for indicating bearers served by the second user equipment.

According to the method performed by the first user equipment provided by the disclosure, wherein the first bearer information comprises at least one of the followings: second number information for indicating a number of bearers of the first user equipment; identification information of the first bearer; or first quality of service information including the quality of service that the first user equipment needs to satisfy on the link from the second user equipment to the first network node, and/or the quality of service that the first user equipment obtains on the first link, and/or the quality of service that the first user equipment needs to satisfy on the second link between the second user equipment and the first network node.

According to the method performed by the first user equipment provided by the disclosure, wherein the second bearer information comprises at least one of the followings: third number information for indicating a number of bearers of the second user equipment, or a number of radio link control RLC channels used, or a number of logical channels used, or a number of available RLC channels; identification information of the second bearer/RLC channel/logical channel; or second quality of service (QoS) information for indicating the QoS that the second user equipment is able to provide for the first user equipment on the second link between the second user equipment and the first network node, and/or the QoS that the second user equipment is able to provide for the first user equipment on the first link.

According to the method performed by the first user equipment provided by the disclosure, wherein the third indication information comprises at least one of the followings: first access indication information for indicating a type of a node that the first network node is allowed to access; second access indication information for indicating information of one or more second user equipment; or third access indication information for indicating information of one or more first user equipment.

According to the method performed by the first user equipment provided by the disclosure, wherein the type of the node that the first network node is allowed to access comprises at least one of the followings: a node that only supports a 3rd generation partnership project (3GPP) protocol; a node that only supports a non-3GPP protocol; a node that supports both the 3GPP protocol and the non-3GPP protocol.

According to the method performed by the first user equipment provided by the disclosure, wherein the second access indication information or the third access indication information comprises at least one of the followings: first list information for indicating the information of one or more first user equipment or second user equipment that only support establishing the first link through the non-3rd generation partnership project (3GPP) protocol; second list information for indicating information of one or more first user equipment or second user equipment that only support establishing the first link through the 3GPP protocol; or third list information for indicating information of one or more first user equipment or second user equipment that support establishing the first link through both the 3GPP protocol and the non-3GPP protocol.

According to the method performed by the first user equipment provided by the disclosure, the method further comprises: sending a fourth message to the first network node, the fourth message is used for informing an access type or mode supported by the first user equipment.

According to the method performed by the first user equipment provided by the disclosure, wherein the access type or mode comprises at least one of the followings: 3rd generation partnership project (3GPP); or non-3GPP.

According to the method performed by the first user equipment provided by the disclosure, wherein the fourth message comprises at least one of the followings: first equipment type information, wherein the first equipment type information is at least one of the followings: remote user equipment or relay user equipment; first access type or mode information for indicating the type or mode of the first link.

According to the method performed by the first user equipment provided by the disclosure, wherein the first identification information, the second identification information, the association identification information, the first user equipment identification, the second user equipment identification, the sixth identification indication information or the seventh identification indication information comprises at least one of the followings: identification information on the a direct path; a first identification related to the first link; a second identification related to the first link; or cell identification information.

According to the method performed by the first user equipment provided by the disclosure, wherein the first identification or the second identification related to the first link is assigned by the first network node or by a node on the first link.

According to the method performed by the first user equipment provided by the disclosure, wherein the sixth identification indication information or the seventh identification indication information further comprises third type or mode information for indicating a type of the first link supported by the first user equipment or the second user equipment.

According to the method performed by the first user equipment provided by the disclosure, wherein the seventh identification indication information further comprises fourth access indication information for indicating whether the second user equipment establishes a connection with other user equipment except the first user equipment.

According to the method performed by the first user equipment provided by the disclosure, wherein the first user equipment is a first node or a second node, and the second user equipment is the first node or the second node, wherein the first node is a node that performs data transmission with the first network node through a relay node on the first link, and the second node is a relay node connected with the first network node on the first link.

According to the method performed by the first user equipment provided by the disclosure, wherein the first node is remote user equipment and the second node is relay user equipment.

According to another aspect of the disclosure, there is provided a method performed by a first network node, the method comprises: receiving a first message sent by first user equipment, the first message is used for informing information related to a type or mode of a first link; sending a second message to the first user equipment, the second message is used for configuring the first user equipment to perform data transmission with the first network node through the first link between the first user equipment and a second user equipment.

According to the method performed by the first network node provided by the disclosure, wherein the first message comprises at least one of the followings: first identification indication information for indicating identification information of the first user equipment and/or the second user equipment; first measurement indication information for indicating a measurement result of the first user equipment; or second measurement indication information for indicating a measurement result of the second user equipment.

According to the method performed by the first network node provided by the disclosure, wherein the first identification indication information comprises at least one of the followings: first identification information including identification information of the first user equipment; second identification information including identification information of the second user equipment; or third identification information including an identification pair of an identification of the first user equipment and an identification of the second user equipment.

According to the method performed by the first network node provided by the disclosure, wherein the first measurement indication information or the second measurement indication information comprises at least one of the followings: association identification information for indicating the measured first user equipment or the second user equipment; measurement result information for indicating a measurement result of the first link by the first user equipment or the second user equipment; or first type or mode information for indicating a type or mode of the first link.

According to the method performed by the first network node provided by the disclosure, wherein the measurement result information comprises at least one of the followings: signal strength information; indication information of a signal quality or link quality for indicating a quality of the first link; parameter information of an obtainable quality of service (QoS) for indicating a quality of service that the first user equipment is able to reach on the first link; or priority indication information for indicating a priority of the second user equipment or the first user equipment.

According to the method performed by the first network node provided by the disclosure, wherein the first measurement indication information or the second measurement indication information comprises a list composed of at least an association identification information and/or the measurement result information corresponding to the at least an association identification information.

According to the method performed by the first network node provided by the disclosure, wherein the priority is determined based on a position of the association identification information corresponding to the user equipment in the association identification information list in the measurement indication information.

According to the method performed by the first network node provided by the disclosure, wherein the corresponding user equipment indicated by the association identification information in the list is a node which satisfies a preset condition, or a number of the corresponding user equipment indicated by the association identification information in the list satisfies a predetermined number.

According to the method performed by the first network node provided by the disclosure, wherein the second message comprises at least one of the followings: first user equipment identification; a second user equipment identification; or a type or mode of the first link.

According to the method performed by the first network node provided by the disclosure, wherein the type of the first link comprises at least one of the followings: a 3rd generation partnership project (3GPP) link; or a non-3GPP link.

According to the method performed by the first network node provided by the disclosure, the method further comprises: sending a third configuration message to the first user equipment, the third configuration message is used for configuring the discovery and/or measurement of nodes on the first link by the first user equipment.

According to the method performed by the first network node provided by the disclosure, wherein the third configuration message comprises at least one of the followings: first threshold information for determining threshold information of a candidate second user equipment establishing the first link with the first user equipment; first number information for indicating the maximum number of candidate second user equipment establishing the first link with the first user equipment; first indication information for indicating information of the first user equipment; second indication information for indicating information of the second user equipment; third indication information for indicating one or more first user equipment and/or one or more second user equipment served by the first network node.

According to the method performed by the first network node provided by the disclosure, wherein the first indication information comprises at least one of the followings: sixth identification indication information for indicating the identification of the first user equipment; or first bearer information for indicating bearers required by the first user equipment; and/or wherein the second indication information comprises at least one of the followings: seventh identification indication information for indicating the identification of the second user equipment; or second bearer information for indicating bearers served by the second user equipment.

According to the method performed by the first network node provided by the disclosure, wherein the first bearer information comprises at least one of the followings: second number information for indicating a number of bearers of the first user equipment; identification information of the first bearer; or first quality of service information including the quality of service that the first user equipment needs to satisfy on the link from the second user equipment to the first network node, and/or the quality of service that the first user equipment obtains on the first link, and/or the quality of service that the first user equipment needs to satisfy on the second link between the second user equipment and the first network node.

According to the method performed by the first network node provided by the disclosure, wherein the second bearer information comprises at least one of the followings: third number information for indicating a number of bearers of the second user equipment, or a number of radio link control RLC channels used, or a number of logical channels used, or a number of available RLC channels; identification information of the second bearer/RLC channel/logical channel; or second quality of service (QoS) information for indicating the QoS that the second user equipment is able to provide for the first user equipment on the second link between the second user equipment and the first network node, and/or the QoS that the second user equipment is able to provide for the first user equipment on the first link.

According to the method performed by the first network node provided by the disclosure, wherein the third indication information comprises at least one of the followings: first access indication information for indicating a type of a node that the first network node is allowed to access; second access indication information for indicating information of one or more second user equipment; or third access indication information for indicating information of one or more first user equipment.

According to the method performed by the first network node provided by the disclosure, wherein the type of the node that the first network node is allowed to access comprises at least one of the followings: a node that only supports a 3rd generation partnership project (3GPP) protocol; a node that only supports a non-3GPP protocol; a node that supports both the 3GPP protocol and the non-3GPP protocol.

According to the method performed by the first network node provided by the disclosure, wherein the second access indication information or the third access indication information comprises at least one of the followings: first list information for indicating the information of one or more first user equipment or second user equipment that only support establishing the first link through the non-3rd generation partnership project (3GPP) protocol; second list information for indicating information of one or more first user equipment or second user equipment that only support establishing the first link through the 3GPP protocol; or third list information for indicating information of one or more first user equipment or second user equipment that support establishing the first link through both the 3GPP protocol and the non-3GPP protocol.

According to the method performed by the first network node provided by the disclosure, the method further comprises: receiving a fourth message sent by the first user equipment, the fourth message is used for informing an access type or mode supported by the first user equipment.

According to the method performed by the first network node provided by the disclosure, wherein the access type or mode comprises at least one of the followings: 3rd generation partnership project (3GPP); or non-3GPP.

According to the method performed by the first network node provided by the disclosure, wherein the fourth message comprises at least one of the followings: first equipment type information, wherein the first equipment type information is at least one of the followings: remote user equipment or relay user equipment; first access type or mode information for indicating the type or mode of the first link.

According to the method performed by the first network node provided by the disclosure, wherein the first identification information, the second identification information, the association identification information, the first user equipment identification, the second user equipment identification, the sixth identification indication information or the seventh identification indication information comprises at least one of the followings: identification information on a direct path; a first identification related to the first link; a second identification related to the first link; or cell identification information.

According to the method performed by the first network node provided by the disclosure, wherein the first identification or the second identification related to the first link is assigned by the first network node or by a node on the first link.

According to the method performed by the first network node provided by the disclosure, wherein the sixth identification indication information or the seventh identification indication information further comprises third type or mode information for indicating the type of the first link supported by the first user equipment or the second user equipment.

According to the method performed by the first network node provided by the disclosure, wherein the seventh identification indication information further comprises fourth access indication information for indicating whether the second user equipment establishes a connection with other user equipment except the first user equipment.

According to the method performed by the first network node provided by the disclosure, wherein the first user equipment is a first node or a second node, and the second user equipment is the first node or the second node, wherein the first node is a node that performs data transmission with the first network node through a relay node on the first link, and the second node is a relay node connected with the first network node on the first link.

According to the method performed by the first network node provided by the disclosure, wherein the first node is remote user equipment and the second node is relay user equipment.

According to the method performed by the first network node provided by the disclosure, the method further comprises sending a third message to a second network node, the third message is used for requesting the second network node to configure the first user equipment and/or the second user equipment.

According to the method performed by the first network node provided by the disclosure, the third message comprises at least one of the followings: first user equipment identification; a second user equipment identification; the type or mode of the first link.

According to another aspect of the disclosure, there is provided a method performed by a second network node, the method comprises: receiving a third message sent by the first network node, the third message is used for requesting the second network node to configure first user equipment and/or a second user equipment; receiving data sent by the second user equipment or a first network equipment, and processing the received data based on the third message.

According to the method performed by the second network node provided by the disclosure, the third message comprises at least one of the followings: first user equipment identification; a second user equipment identification; a type or mode of a first link.

According to the method performed by the second network node provided by the disclosure, wherein receiving the data sent by the second node, and processing the received data based on the third message comprises at least one of the followings: based on third type information included in the third message indicating a 3rd generation partnership project (3GPP) link, reading header information of the data, and sending the data with the header information removed to a corresponding path for data transmission; based on the third type information indicating a non-3GPP link, sending the received data to the corresponding path for data transmission based on the air interface radio link (Uu RLC) channel or the logical channel to which the received data belongs; or based on the third type information indicating the non-3GPP link, reading protocol layer header information of the data, and sending the data to the corresponding path for data transmission base on the protocol layer header information.

According to the method performed by the second network node provided by the disclosure, wherein receiving the data sent by the first network node, and processing the received data based on the third message comprises at least one of the followings: based on third type information included in the third message indicating a 3rd generation partnership project (3GPP) link, adding header information to the data, the header information comprises identification information of the bearer to which the data packet belongs and/or identification information of the user; based on the third type information indicating a non-3GPP link, sending the data to the second node through the air interface radio link (Uu RLC) channel or the logical channel to which the data belongs; or based on the third type information indicating the non-3GPP link, adding the identification information of the bearer to which the data belongs and/or the identification information of the user to protocol layer header of the data.

According to another aspect of the disclosure, there is provided first user equipment comprising a transceiver configured to transmit and receive signals with the outside; and a processor configured to control the transceiver to perform the methods performed by the first user equipment.

According to another aspect of the disclosure, there is provided a first network node, the first user equipment comprises a transceiver configured to transmit and receive signals with the outside; and a processor configured to control the transceiver to perform the methods performed by the first network node.

According to another aspect of the disclosure, there is provided a second network node, and the first user equipment comprises a transceiver configured to transmit and receive signals with the outside; and a processor configured to control the transceiver to perform the methods performed by the second network node.

According to another aspect of the disclosure, there is provided a non-transitory computer-readable recording medium, on which a program for performing any one of the above methods when run by a computer has been stored.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

FIG. 1 is an exemplary system architecture of System Architecture Evolution (SAE).

FIG. 2 is an exemplary system architecture according to various embodiments of the disclosure.

FIG. 3 is a schematic diagram of a centralized unit and a distributed unit of a base station according to various embodiments of the disclosure.

FIG. 4 is a flowchart of a method performed by first user equipment according to various embodiments of the disclosure.

FIG. 5 illustrates a schematic diagram of interaction between first user equipment and a first network node provided by an embodiment of the invention.

FIG. 6 illustrates another schematic diagram of interaction between first user equipment and a first network node provided by an embodiment of the invention.

FIG. 7 is a block diagram illustrating a structure of first user equipment according to an embodiment of the disclosure.

FIG. 8 is a block diagram illustrating a structure of a first network node according to an embodiment of the disclosure.

FIG. 9 is a block diagram illustrating a structure of a second network node according to an embodiment of the disclosure.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

The following description with reference to the accompanying drawings is provided to facilitate a comprehensive understanding of various embodiments of the disclosure as defined by the claims and their equivalents. This description includes various specific details to facilitate understanding but should only be considered as exemplary. Therefore, those skilled in the art will recognize that various changes and modifications may be made to the various embodiments described herein without departing from the scope and spirit of the disclosure. In addition, for the sake of clarity and conciseness, descriptions of well-known functions and structures may be omitted.

The terms and expressions used in the following specification and claims are not limited to their dictionary meanings, but are only used by the inventors to enable a clear and consistent understanding of the disclosure. Therefore, it should be obvious to those skilled in the art that the following descriptions of various embodiments of the disclosure are provided for illustration purposes only and are not intended to limit the purposes of the disclosure as defined in the appended claims and their equivalents.

It should be understood that singular forms of “a”, “an” and “the” include plural referents unless the context clearly indicates otherwise. Thus, for example, a reference to a “component surface” includes a reference to one or more such surfaces.

The terms “include” or “may include” refer to the existence of a corresponding disclosed function, operation or component that may be used in various embodiments of the disclosure, without limiting the existence of one or more additional functions, operations or features. In addition, the terms “include” or “have” may be interpreted as indicating certain characteristics, numbers, steps, operations, constituent elements, components or combinations thereof, but should not be interpreted as excluding the possibility of the existence of one or more other characteristics, numbers, steps, operations, constituent elements, components or combinations thereof.

The term “or” used in various embodiments of the disclosure includes any of the listed terms and all combinations thereof. For example, “A or B” may include A, may include B, or may include both A and B.

Unless defined differently, all terms (including technical terms or scientific terms) used in this disclosure have the same meaning as those understood by those skilled in the art in this disclosure. General terms, as defined in dictionaries, are interpreted as having meanings consistent with the context in relevant technical fields, and should not be interpreted in an idealized or overly formal way unless explicitly defined in this disclosure.

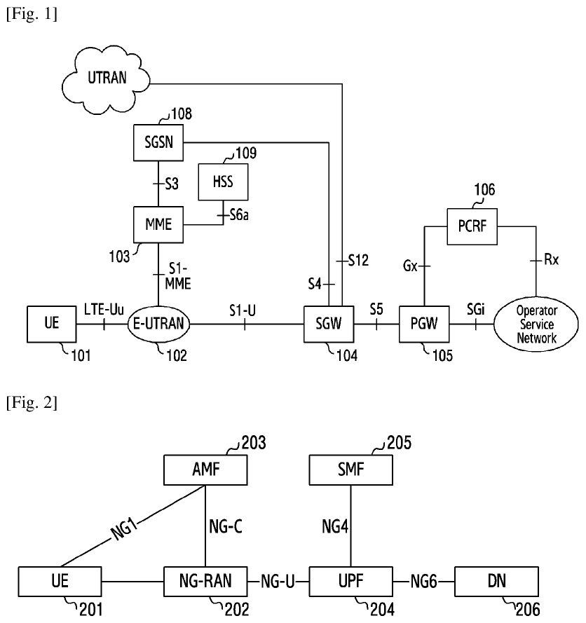

FIGS. 1 to 9 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

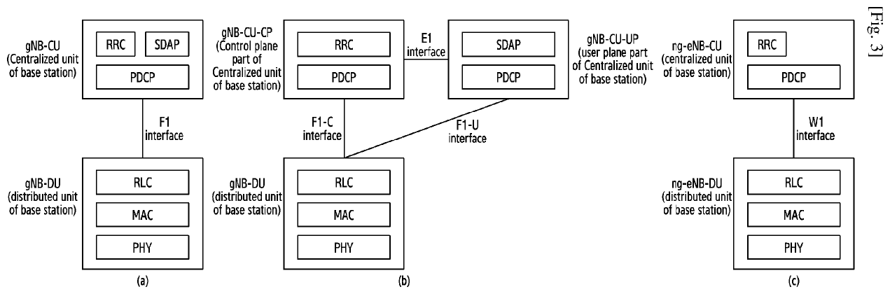

FIG. 2 is an exemplary system architecture 200 according to various embodiments of the disclosure. Other embodiments of the system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

Generally, the user equipment communicates through a direct path with the base station. However, with increasement of users and improvement of frequency of a cell, the coverage of the cell is limited and the data transmission rate which the cell may provide is limited. In order to solve this problem, a sidelink relay technology is proposed, that is, the base station communicates with the user equipment through a relay terminal. In an implementation, a user terminal is connected to the network through an air interface link (direct path) directly connected to the network. In another implementation, the user terminal is connected to the network through the relay terminal (indirect path). However, at present, the user equipment may not connect to the network through both the direct path and the indirect path simultaneously.

Further, before the user terminal communicates with the base station through the indirect path, it needs to establish a communication link with the relay terminal. In an implementation, the user terminal may establish a connection with the relay terminal through an existing 3GPP technology (such as Sidelink or PC5 technology), and then the user terminal and the relay terminal may interact with the base station respectively to know the configuration of the link between the user terminal and the relay terminal, thus completing the establishment or addition of the indirect path. In another embodiment, the user terminal may also establish the connection with the relay terminal through a non-3GPP technology (such as Proprietary link between terminal devices), and the base station may not know information of the link between the user terminal and the relay terminal (such as identification information of the user terminal/relay terminal, link quality of the link using the non-3GPP technology, etc.) due to un-awareness of the non-3GPP technology, and thus may not correctly configure the establishment or addition of the indirect path.

Therefore, how to conduct the establishment or addition of the indirect path between the user terminal and the base station is an urgent problem. For example, an example is how to conduct the establishment or addition of the indirect path between the user terminal and the base station when the user terminal communicates with the relay terminal through the non-3GPP technology. Another example is how to conduct the establishment or addition of the indirect path between the user terminal and the base station when the user equipment may support communication with the relay terminal through the non-3GPP technology and the 3GPP technology.

However, it may be understood that the technical problem to be solved in this aspect is not limited to the above problem, and any technical problem that may be solved by the inventive concept of this disclosure belongs to the scope protected by this disclosure.

In addition, in NR system, in order to support network function virtualization, more efficient resource management and scheduling, the base station (gNB/ng-eNB) providing a wireless network interface for the user equipment (UE) may be further split into a centralized unit (gNB central unit/ng-eNB central unit (gNB-CU/ng-eNB-CU)) and a distributed unit (gNB distributed unit/ng-eNB distributed unit (gNB-DU/ng-eNB-DU)), abbreviated as CU and DU in the invention.

In order to be more flexibly applied to the current network environment, various embodiments of the disclosure may also be used in scenarios where the base station is split into the centralized unit and the distributed unit. Different arrangements of the centralized unit and the distributed unit of the base station in various embodiments of the disclosure will be introduced with reference to FIG. 3 below.

Please refer to FIG. 3, which is a schematic diagram of a centralized unit and a distributed unit of a base station according to various embodiments of the disclosure.

As shown in FIG. 3(a), the gNB-CU has radio resource control (RRC), service data adaptation protocol (SDAP) and packet data convergence protocol (PDCP) layers, while the ng-eNB-CU has RRC and PDCP layers. The gNB-DU/ng-eNB-DU has radio link control protocol (RLC), medium access control (MAC) and physical layers. There is a standardized public interface F1 between the gNB-CU and the gNB-DU, and a standardized public interface W1 between ng-eNB-CU and ng-eNB-DU. The F1 interface is divided into a control plane F1-C and a user plane F1-U. The transport network layer of F1-C is based on IP transmission. In order to transmit signaling more reliably, a stream control transmission protocol (SCTP) is added over the IP. The protocol of the application layer is F1 Application Protocol (F1AP), see 3GPP TS38.473. The SCTP may provide reliable application layer message transmission. The transport layer of F1-U is UDP/IP, and GTP-U is used to carry a user plane protocol data unit PDU over UDP/IP.

Further, for the gNB-CU, as shown in FIG. 3(b), the gNB-CU may include a gNB-CU-CP (the control plane part of the centralized unit of the base station) and a gNB-CU-UP (the user plane part of the centralized unit of the base station), the gNB-CU-CP contains functions of the control plane of the base station and has RRC and SDAP protocol layers, and the gNB-CU-UP contains functions of the user plane of the base station and has SDAP and PDCP layers. There is a standardized public interface E1 with protocol E1AP between the gNB-CU-CP and the gNB-CU-UP, see 3GPP TS38.463. The interface between the control plane part of the centralized unit of the base station and the distributed unit of the base station is F1-C interface, that is, the control plane interface of F1, and the interface between the user plane part of the centralized unit of the base station and the distributed unit of the base station is F1-U interface, that is, the user plane interface of F1.

In addition, in the NR system, the base station providing the E-UTRA user plane and control plane accessing the 5G core network is called ng-eNB. In order to support virtualization, such base station (ng-eNB) may also be further split into the centralized unit ng-eNB-CU (gNB central unit/ng-eNB central unit) and the distributed unit ng-eNB-DU (gNB distributed unit/ng-eNB distributed unit), abbreviated as CU and DU in the invention, as shown in FIG. 3(c). The ng-eNB-CU has RRC and PDCP layers. The gNB-DU/ng-eNB-DU has radio link control protocol (RLC), medium access control (MAC) and physical layers. There is a standardized public interface W1 between the ng-eNB-CU and the ng-eNB-DU. The W1 interface is divided into a control plane W1-C and a user plane W1-U. The transport network layer of W1-C is based on IP transmission. In order to transmit signaling more reliably, the SCTP protocol is added over the IP. The protocol of the application layer is W1AP, see 3GPP TS37.473. The transport layer of W1-U is UDP/IP, and GTP-U is used to carry the user plane protocol data unit PDU over UDP/IP.

Before introducing specific contents, some assumptions and some definitions of the invention are given below.
Message names in the invention are only examples, and other message names may be used.
The “first” and “second” etc. included in message names of the invention are only examples of messages and do not represent the execution order.
Detailed description of steps irrelevant to the invention is omitted in the invention.
In the invention, steps in each flow may be executed in combination with each other or performed separately. The execution order of each flow is only example, and other possible execution orders are not excluded.
In the invention, the base station may be a 5G base station (such as gNB, ng-eNB), a 4G base station (such as eNB) or other types of access nodes.
In the invention, transmission of data refers to the receiving or sending of the data.
In the invention, cell identification information may be a Primary Cell identification (ID), a Primary Secondary cell identification (ID) or a Special primary Cell identification (ID).

Nodes involved in the invention include the following nodes:
a first node: a user terminal, such as remote user equipment (Remote UE). In an embodiment, the terminal may directly communicate with a base station; in another embodiment, the terminal may communicate with the base station through another terminal (such as the relay terminal); in another embodiment, the terminal may communicate with the base station directly or through another terminal.
a second node: a relay terminal, such as relay UE, which directly communicates with the base station and may provide relay services for another terminal, that is, another terminal may communicate with the base station through the relay terminal.
a third node: a distributed unit of a base station. The second node sends data of the first node to the third node, and the third node forwards the data to a fourth node; or the second node sends the data from the third node to the first node.
a fourth node: a centralized unit of a base station, or a control plane part of a centralized unit of the base station, or a user plane part of the base station.
a fifth node: a base station, which may be composed of the above third node and fourth node or an independent base station.

The invention involves to two communication paths:
a direct path: the direct path indicates a path for data transmission between the user terminal and the network. On the path, the user terminal is directly connected with the network (for example, through an air interface link between the user terminal and the network), and data is transmitted on the path.
an indirect path: the indirect path indicates another path for data transmission between the user terminal and the network. On the path, there is another terminal (such as the relay terminal) between the user terminal and the network. In an example, there is a sidelink (or PC5 link) or other proprietary link (such as a non-3GPP links, an ideal UE-UE link, a WIFI link, etc.) between the user terminal and another terminal, and there are air interface links (Uu link) between another terminal and the network, and data transmission between the user terminal and the network is relayed through another terminal.

Links involved in the invention:
a first link: the link is a link between a user terminal (remote UE) and a relay terminal (such as relay UE). In an embodiment, technologies used on the first link may be technologies defined by 3GPP, such as a sidelink, PC5, etc. In another embodiment, the technologies used on the first link may be non-3GPP technologies, such as a Proprietary technology and an ideal UE-UE link, WIFI etc. implementations of which are unknown to a base station.
a second link: the link is a link between the relay terminal and the base station (or the distributed unit of the base station), and the link adopts the air interface technology defined by 3GPP.
a third link: the link is the link between the user terminal and the base station (or a distributed unit of the base station), and the link adopts the air interface technology defined by 3GPP.
the first link and the second link constitute the indirect path, and the third link constitutes the direct path.

After considering the relay terminal, communication between the user terminal and the network may following the following scenarios:
scenario 1 (adding the indirect path): the user terminal is communicating with the network through a direct path, and then the network adds an indirect path for the user terminal.
scenario 2 (establishing the indirect path): the user terminal establishes the connection with the network through an indirect path, such as establishing/restarting/reconstructing the connection through the indirect path.

Solutions of the invention includes at least the following two types:
the establishment or addition of the indirect path is completed based on the report of the first node, that is, the first node reports information of one or more second nodes on the first link measured by the first node to the network side, and then the network side decides the second node to establish the first link with the first node.
the establishment or addition of the indirect path is completed based on the report of the second node, that is, the second node reports information of the first node on the first link measured by the second node to the network side, and then the network side decides the first node to establish the first link with the second node.

The above two solutions define following nodes:
first user equipment: the equipment may be the first node or the second node.
a second user equipment: a node different from the first user equipment, when the first user equipment is the first node, the second user equipment is the second node, and when the first user equipment is the second node, the second user equipment is the first node.
a first network node: the node may be the fifth node or the fourth node.
a second network node: when the first network node is the fourth node, the second network node is the third node.

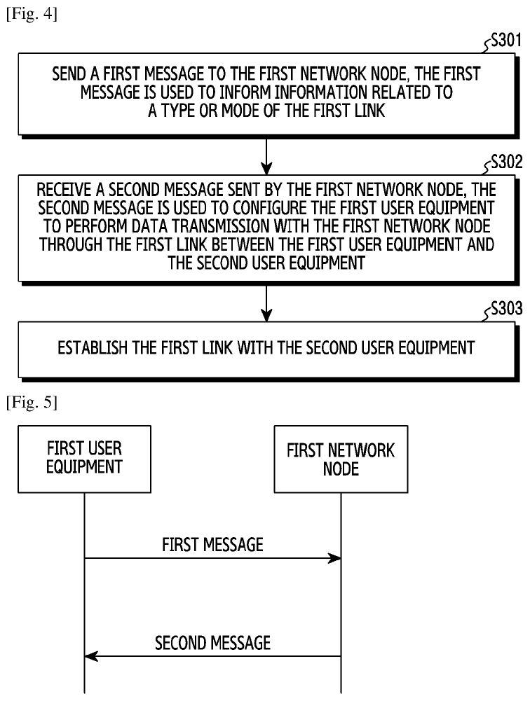

A method performed by the first user equipment provided by an embodiment of the disclosure will be described below with reference to FIGS. 4 to 5.

Please refer to FIG. 4, which is a flowchart of the method performed by the first user equipment according to various embodiments of the disclosure. FIG. 5 illustrates a schematic diagram of interaction between the first user equipment and the first network node provided by an embodiment of the invention. The method performed by the first user equipment may include steps S301 and S302.

At step S301: send a first message to the first network node, the first message is used to inform information related to a type or mode of the first link (as shown in Step 1-1 in FIG. 5).

As an implementation, the first message may include at least one of the followings: first identification indication information for indicating identification information of the first user equipment and/or the second user equipment; first measurement indication information for indicating a measurement result of the first user equipment; or second measurement indication information for indicating a measurement result of the second user equipment.

The detailed implementation of the first message will be described in more details below.

At step S302: receive a second message sent by the first network node, the second message is used to configure the first user equipment to perform data transmission with the first network node through the first link between the first user equipment and the second user equipment (as shown in step 1-2 in FIG. 5).

As an implementation, the second message may include at least one of the followings: a first user equipment identification; a second user equipment identification; or the type or mode of the first link.

The detailed implementation of the second message will be described in more details below.

Further, please refer to FIG. 4. As one of the implementations, the method may further include: at step S303, establishing the first link with the second user equipment.

As an implementation, the type of the first link may include at least one of the followings: a 3rd generation partnership project (3GPP) link; or a non-3GPP link.

As an implementation, the first user equipment is the first node or the second node, and the second user equipment is the first node or the second node, wherein the first node is a node that performs data transmission with the first network node through a relay node on the first link, and the second node is a relay node connected with the first network node on the first link.

As an implementation, the first node may be remote user equipment, and the second node may be relay user equipment.

Through the above method, the establishment or addition of the indirect path between the user terminal and the network node may be implemented, such that when the user equipment has established the direct path with the network node, the user equipment may be connected with the network through the direct path and the indirect path simultaneously, or when the user equipment does not establish the connection with the network node, the user equipment may be connected with the network through the indirect path. Further, by sending, by the first user equipment, a first notification message for informing the information related to the type or mode of the first link to the first network node, the user terminal and the relay terminal may be configured according to the type or mode of the link between the user terminal and the relay terminal when the user terminal communicates with the network through the relay terminal, and the establishment or addition of the indirect path between the user terminal and the base station is implemented.

In addition, specific implementations of the first message and the second message will be introduced with more detailed embodiments below.

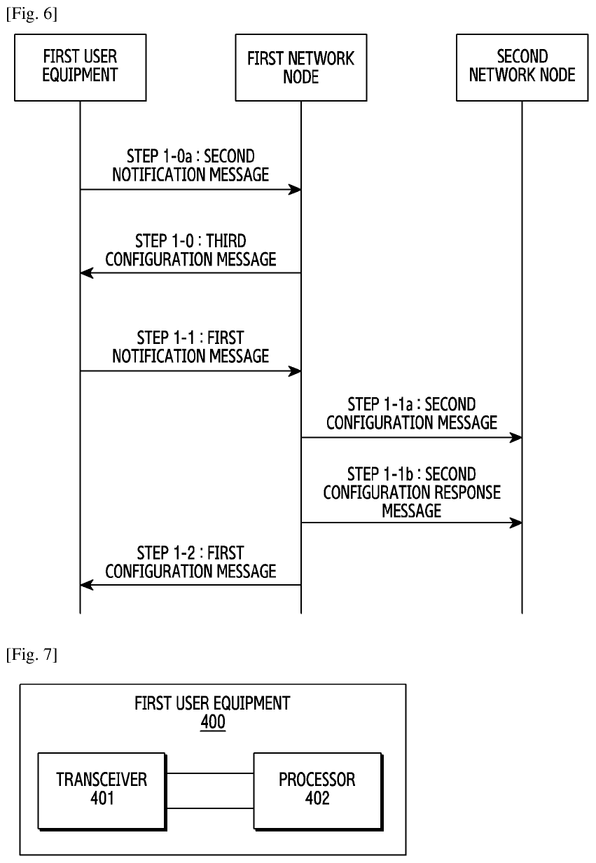

It may be understood that the implementation of steps 1-1 and 1-2 in FIG. 5 may be same as or similar to the implementation of steps 1-1 and 1-2 in FIG. 6. In addition, in the application, same messages may be named in different ways, and same contents in messages may be expressed in different ways. However, it may be understood that messages or contents in messages named in different ways or expressions may refer to same or similar messages or contents in messages. For example, the first message in FIG. 5 may be same as or similar to the first notification message in FIG. 6, and the second message in FIG. 5 may be same as or similar to a first configuration message in FIG. 6, etc., which will not be described again.

In addition, the disclosure is mainly described from the perspective of the first user equipment, but it may be understood that since the disclosure is an interaction method among the first user equipment, the first network node and the second network node, based on the method performed by the first user equipment described here, the method performed by the first network node or the second network node is also clear to those skilled in the art. For the sake of brevity, after describing the method performed by the first user equipment in detail, the method performed by the first network node or the second network node as a unilateral execution subject will not be described in detail, but the method performed by the first network node or the second network node also belongs to the protection scope of the disclosure.

The method performed by the first user equipment provided by an embodiment of the disclosure will be described in more details with reference to FIG. 6. The method performed by the first user equipment includes the following steps:

At step 1-1: the first user equipment sends the first notification message used to inform the information related to the first link to the first network node, so as to help the first network node to determine the establishment or addition of the indirect path. The message contains at least one of the following information:
first identification indication information, which contains identification information of the first node and/or the second node on the first link and includes at least one of the following information:
first identification information, which contains identification information of the first node and may include at least one of the following information:
identification information of the first node on the direct path, such as Cell-RadioNetworkTemporaryIdentifier (C-RNTI), C-RNTI and cell identification information (such as Primary Cell ID, Primary Secondary cell ID and Special primary Cell ID);
an identification assigned to the first node on the first link (such as an identification assigned by the non-3GPP technology, such as a non-3GPP ID). In an implementation, the identification is assigned by the second node. In another implementation, the identification is assigned by the first node;
an identification (such as a non-3GPP ID) used on the first link assigned by the first network node for the first node.
second identification information, which contains identification information of the second node. In an implementation, the identification information indicates that the first node has established the first link with the second node indicated by the second identification information. The information may include at least one of the following information:
identification information of the second node on the direct path, such as C-RNTI, C-RNTI and cell identification information;
an identification assigned to the second node on the first link (such as an identification assigned by the non-3GPP technology, such as a non-3GPP ID). In an implementation, the identification is assigned by the second node. In another implementation, the identification is assigned by the first node.
an identification (such as a non-3GPP ID) used on the first link assigned by the first network node for the second node.
third identification information, which indicates an identification (ID) pair composed of a first node identification (such as the first identification information described above) and a second node identification (such as the second identification information described above). In an embodiment, the identification pair indicates the first link that the first node and the second node have established.
first measurement indication information, which indicates the measurement result of the first node, and the measurement result may be obtained after the first node establishes the connection with the second node or when the first node does not establish the connection with the second node. In an embodiment, the measurement result is a measurement result for the first link, after receiving the information, the first network node determines link condition of the first link measured by the first node, and then selects a suitable second node based on this information, or determines whether to establish or add the indirect path. Beneficial effect of this information is to help the first network node to select the suitable second node for the first node, or obtain the information of the second node establishing the first link with the first node, or determine the establishment or addition of the indirect path, and the information includes at least one of the following information:
first association identification information, which indicates the second node measured by the first node or the second node that has established the connection with the first node, and includes at least one of the following information:
identification information of the second node on the direct path, such as C-RNTI, C-RNTI and cell identification information;
an identification assigned to the second node on the first link (such as an identification assigned by the non-3GPP technology, such as a non-3GPP ID). In an implementation, the identification is assigned by the second node. In another implementation, the identification is assigned by the first node;
an identification (such as a non-3GPP ID) used on the first link assigned by the first network node for the second node;
cell identification information, which indicates the cell accessed by the second node.
first measurement result information, which indicates the measurement result of the first node for the second node, which includes at least one of the following information:
signal strength information, such as RSRP, RSRQ;
indication information of a signal quality or link quality, which indicates the quality of the first link, such as classifying the link quality into different levels (such as best, better, good, bad, worst, worst), which may indicate the level of the link quality;
parameter information of an obtainable QoS, which may indicate the QoS which the first node may reach on the first link, such as a packet delay budge (PDB), a packet error rate (PER), throughput, etc.
indication information of a priority, such as 1, 2, 3, . . . This information indicates the priority of the second node identified by the above first association identification information, such as “1” indicating the highest priority, “2” indicating the second highest priority, or “1” indicating the lowest priority, “2” indicating the second lowest priority, etc.
first type (or mode) information, which indicates the type (or mode) of the first link, such as a 3GPP link, a sidelink, a PC5 link, a link supporting a first scenario (a scenario where the first link adopts 3GPP technology), a non-3GPP link, an ideal UE-UE link, a Proprietary link, a WIFI link and a link supporting a second scenario (a scenario where the first link adopts non-3GPP technology). This information may help the first network node to configure the first node and the second node for different types (or modes) of first links.

The above “first measurement indication information” may contain information of one or more measured second nodes, and each information reflects the information of the link between the first node and one second node. Specifically, the above “first measurement indication information” contain a plurality of groups of “first association identification information” and/or “first measurement result information”, and each group may reflect link information between the first node and one second node. In another embodiment, in order to reflect the link information between the first node and a different second node, the above “first measurement indication information” may only contain one list containing a plurality of “first association identification information”, and the order of the “first association identification information” in the list may reflect different priorities, such as the second node indicated by the first “first association identification information” in the list has the highest (lowest) priority, the second node indicated by the second “first association identification information” in the list has the second highest (lowest) priority, and so on. For example, the above implementation may be implemented by a pre-configured method, and beneficial effect of this implementation is that the first network node may directly determine priorities of different second nodes according to the order of the “first association identification information” in the list; and in another embodiment, the second node indicated by one or more “first association identification information” contained in the above “first measurement indication information” is a node that satisfies a certain condition. An example of the “certain condition” may be that PER is lower than a threshold, and another example may be that PDB is lower than a threshold, throughput is higher than a threshold, etc. The above threshold may be pre-configured by the first network node to the first node; and in another embodiment, the above “first measurement indication information” only contains a certain number of second nodes indicated by the “first association identification information”, and these included nodes are the best N relay UEs (such as with the best link quality, the best QoS parameter requirement satisfied, the best performance in establishing the first link with the first node, etc.). The above “certain number” may be pre-configured by the first network node to the first node.
second measurement indication information, which indicates the measurement result of the second node, and the measurement result may be obtained after the first node establishes the connection with the second node or when the first node does not establish the connection with the second node. In an embodiment, the measurement result is a measurement result for the first link, after receiving the information, the first network node determines link condition of the first link measured by the second node, and then selects a suitable first node based on this information, or determines whether to establish or add the indirect path. Beneficial effect of this information is to help the first network node to select the suitable first node for the second node, or obtain the information of the first node establishing the first link with the second node, or determine the establishment or addition of the indirect path, and the information includes at least one of the following information:
second association identification information, which indicates the first node measured by the second node or the first node that has established the connection with the second node, and includes at least one of the following information:
identification information of the first node on the direct path, such as C-RNTI, C-RNTI and cell identification information;
an identification assigned to the first node on the first link (such as an identifier assigned by the non-3GPP technology, such as a non-3GPP ID). In an implementation, the identification is assigned by the second node. In another implementation, the identification is assigned by the first node.
an identification (such as a non-3GPP ID) used on the first link assigned by the first network node for the first node;
cell identification information, which indicates the cell accessed by the first node, such as the cell on the direct path.
second measurement result information, which indicates the measurement result of the second node for the first node, which includes at least one of the following information:
signal strength information, such as RSRP, RSRQ;
indication information of a signal quality or link quality, which indicates the quality of the first link, such as classifying the link quality into different levels (such as best, better, good, bad, worst, worst), which may indicate the level of the link quality;
parameter information of an obtainable QoS, which may indicate the QoS which the first node may reach on the first link, such as a packet delay budge (PDB), a packet error rate (PER), throughput, etc.
indication information of a priority, such as 1, 2, 3, . . . This information indicates the priority of the first node identified by above the second association identification information, such as “1” indicating the highest priority, “2” indicating the second highest priority, or “1” indicating the lowest priority, “2” indicating the second lowest priority, etc.
second type (or mode) information, which indicates the type (or mode) of the first link, such as a 3GPP link, a sidelink, a PC5 link, a link supporting a first scenario (a scenario where the first link adopts 3GPP technology), a non-3GPP link, an ideal UE-UE link, a Proprietary link, a WIFI link and a link supporting a second scenario (a scenario where the first link adopts non-3GPP technology). This information may help the first network node to configure the first node and the second node for different types (or modes) of first links.

The above “second measurement indication information” may contain information of one or more measured first nodes, and each information reflects the information of the link between the second node and one first node. Specifically, the above “second measurement indication information” contain a plurality of groups of “second association identification information” and/or “second measurement result information”, and each group may reflect link information between the second node and one first node. In another embodiment, in order to reflect the link information between the second node and a different first node, the above “second measurement indication information” may only contain one list containing a plurality of “second association identification information”, and the order of the “second association identification information” in the list may reflect different priorities, such as the first node indicated by the first “second association identification information” in the list has the highest (lowest) priority, the first node indicated by the second “second association identification information” in the list has the second highest (lowest) priority, and so on. Beneficial effect of this implementation is that the first network node may directly determine priorities of different first nodes according to the order of the “second association identification information” in the list; and in another embodiment, the first node indicated by one or more “second association identification information” contained in the above “second measurement indication information” is a node that satisfies a certain condition. An example of the “certain condition” may be that PER is lower than a threshold, and another example may be that PDB is lower than a threshold, throughput is higher than a threshold, etc. The above threshold may be pre-configured by the first network node to the second node; and in another embodiment, the above “second measurement indication information” only contains a certain number of first nodes indicated by the “second association identification information”, and these included nodes are the best N remote UEs (such as with the best link quality, the best QoS parameter requirement satisfied, the best performance in establishing the first link with the first node, etc.). The above “certain number” may be pre-configured by the first network node to the second node.

At step 1-2: the first network node sends the first configuration message to the first user equipment, when the first user equipment is the first node, the message is used to configure the first link in the indirect path of the first node, such as adding or modifying the first link for the first node (configuring a second node to which the first node needs to connect) after the first node has a direct path, or configuring the first node to access the network through the indirect path, and when the first user equipment is the second node, the message is used to configure the first link of the second node, such as configuring the first node to establish the first link with the second node. The message includes at least one of the following information:
second identification indication information, which indicates the second node to which the first node needs to connect, and the information includes at least one of the following information:
identification information of the second node on the direct path, such as C-RNTI, C-RNTI and cell identification information;
an identification assigned to the second node on the first link (such as an identifier assigned by the non-3GPP technology, such as a non-3GPP ID). In an implementation, the identification is assigned by the second node. In another implementation, the identification is assigned by the first node;
an identification (such as a non-3GPP ID) used on the first link assigned by the first network node for the second node;
cell identification information, which indicates the cell accessed by the second node.
third identification indication information, which indicates the first node to which the second node needs to connect, and the information includes at least one of the following information:
identification information of the first node on the direct path, such as C-RNTI, C-RNTI and cell identification information;
an identification assigned to the first node on the first link (such as an identification assigned by the non-3GPP technology, such as a non-3GPP ID). In an implementation, the identification is assigned by the second node. In another implementation, the identification is assigned by the first node;
an identification (such as a non-3GPP ID) used on the first link assigned by the first network node for the second node;
cell identification information, which indicates the cell accessed by the second node.
second type (or mode) information, which indicates the type (or mode) of the first link between the first node and the second node indicated by the above “second identification indication information” or the type (or mode) of the first link between the second node and the first node indicated by the above “third identification indication information”. The information may indicate at least one of the following types (or modes): a 3GPP link, a sidelink, a PC5 link, a link supporting a first scenario (a scenario where the first link adopts the 3GPP technology), a non-3GPP link, an ideal UE-UE link, a Proprietary link, a WIFI link and a link supporting a second scenario (a scenario where the first link adopts the non-3GPP technology). The information may help the first node and the second node to establish a connection.
first channel indication information, which indicates the channel used to send the data of the first node. In an embodiment, the channel is a channel between the second node and the first network node or the second network node. If the first node receives the information, the first node determines the channels or resources used for the receiving and sending of the data on the first link according to the information. If the second node receives the information, the second node determines whether the data packet received through the channel indicated by the information needs to be sent to the first node according to the information, the information includes at least one of the following information:
channel identification information, which identifies a channel for data transmission;
logical channel identification information, which identifies a logical channel for user data transmission;
indication information of channel data, which indicates whether the data on the channel is the data of the second node, or whether it is data needs to be relayed, or whether it is the data of the first node. If the second node receives the information, it may determine whether to forward the downlink data on the channel indicated by the above “channel identification information” or “logical channel identification information” to the first node, or whether to use the channel indicated by the above “channel identification information” or “logical channel identification information” to send the uplink data of the first node.
channel list information, the channel included in this information is a channel that carries the data of the first node or a channel that carries only the data of the second node. This information may identify a channel with at least one of the above “channel identification information” and “logical channel identification information”.

After receiving the first configuration message, the first user equipment establishes the connection with the second user equipment according to the node indicated in the above “first configuration message”, so as to help the first node to perform data transmission with the first network node through the second node.

When the base station is of the split architecture, a configuration process between the second network node and the first network node is also included, and the process, on the one hand, may be used to configure the first node and on the other hand, may be used to configure the second node, and the configuration for the first node and the second node may be performed in a message or through different messages. The process includes the following steps:

At step 1-1a: the first network node sends a second configuration message to the second network node, the message is used to request to configure the first node and/or the second node, and contains at least one of the following information:
fourth identification indication information, which indicates the second node to which the first node needs to connect, and the information includes at least one of the following information:
identification information of the second node on the direct path, such as C-RNTI, C-RNTI and cell identification information;
an identification assigned to the second node on the first link (such as an identification assigned by the non-3GPP technology, such as a non-3GPP ID). In an implementation, the identification is assigned by the second node. In another implementation, the identification is assigned by the first node.
an identification (such as a non-3GPP ID) used on the first link assigned by the first network node for the second node;
cell identification information, which indicates the cell accessed by the second node.
fifth identification indication information, which indicates the first node to which the second node needs to connect, and the information includes at least one of the following information:
identification information of the first node on the direct path, such as C-RNTI, C-RNTI and cell identification information;
an identification assigned to the first node on the first link (such as an identification assigned by the non-3GPP technology, such as a non-3GPP ID). In an implementation, the identification is assigned by the second node. In another implementation, the identification is assigned by the first node;
an identification (such as a non-3GPP ID) used on the first link assigned by the first network node for the first node;
cell identification information, which indicates the cell accessed by the first node, such as the cell accessed by the first node on the direct path.
third type (or mode) information, which indicates the type (or mode) of the first link between the first node and the second node indicated by the above “fourth identification indication information” or the type (or mode) of the first link between the second node and the first node indicated by the above “fifth identification indication information”. The information may indicate at least one of the following types (or modes): a 3GPP link, a sidelink, a PC5 link, a link supporting a first scenario (a scenario where the first link adopts the 3GPP technology), a non-3GPP link, an ideal UE-UE link, a Proprietary link, a WIFI link and a link supporting a second scenario (a scenario where the first link adopts the non-3GPP technology). The information may help the first node and the second node to establish a connection. In an embodiment, the information is sent to the second network node through the explicit signalling, in another embodiment, the information is sent to the second network node through capability information of the first node or the second node (for example, information of the type of the first link supported by the first node or the second node is indicated in the capability information of the first node or the second node, and the type indicated by the information is at least one of the above types), and in another embodiment, the information is informed to the second network node implicitly (for example, according to the identification information of the first node or the second node, if the identification information is a non-3GPP ID, it means that the connection between the first node and the second node is established through a non-3GPP technology).
first data information, which indicates the data that needs to be served by the second network node, and further helps the second network node to generate configuration information for serving these data, and the information includes at least one of the following information:
identification information of a bearer, such as DRB ID and SRB ID;
identification information of a channel, such as identification information of Uu RLC channel;
indication information of a tunnel, such as transport layer address information and tunnel endpoint identity (TEID) information;
second channel indication information, which indicates the channel used to send the data of the first node. In an embodiment, the channel is a channel between the second node and the first network node or the second network node. The information includes at least one of the following information:
channel identification information, which identifies a channel for data transmission;
logical channel identification information, which identifies a logical channel for user data transmission;
indication information of channel data, which indicates whether the data on the channel is the data of the second node, or whether it is data needs to be relayed, or whether it is the data of the first node;
channel list information, the channel included in this information is a channel that carries the data of the first node or a channel that carries only the data of the second node. This information may identify a channel with at least one of the above “channel identification information” and “logical channel identification information”.

When the second network node receives the message, at least one of the following behaviours may be included:
behaviour 1: behaviours of processing data packets sent by the second node will vary depending on the above “third type (or mode) information”.

If the “third type (or mode) information” indicates a 3GPP link (such as a sidelink, PC5), the second network node reads packet header information (such as a SRAP sidelink relay adaptation protocol header) of data packet, and the information in the packet header indicates the bearer (identification information of the bearer) and/or the user (identification information of the user) to which the received data belongs, and after reading this information, the second network node removes the packet header and hands the data packet over to the correct path (such as the tunnel between the second network node and the first network node serving the first node, or the path established between the second network node and the first network node for controlling signaling transmission) for transmission. If the third type (or mode) information indicates a non-3GPP link (such as an ideal UE-UE link, a Proprietary link, WIFI), the data packet received by the second network node does not contain an SRAP header, and the second network node hands the data packet over to the correct path (such as the tunnel between the second network node and the first network node serving the first node, or the path established between the second network node and the first network node for controlling signaling transmission) for transmission according to the Uu RLC channel or logical channel to which the received data packet belongs. In another embodiment, the second network node reads the protocol layer header information (such as a RLC layer and a MAC layer) of the received data packet, the information may indicate the identification information of the user to which the data packet belongs and/or the information of the bearer to which the data packet belongs, the information may help the second network node to hand the received data packet over to the correct path (such as the tunnel between the second network node and the first network node serving the first node, or the path established between the second network node and the first network node for controlling signaling transmission) for transmission.
behaviour 2: behaviours of processing the data packet sent by the first network node (or the user plane part of the base station to which the first network node belongs) will vary depending on the above “third type (or mode) information”.

If the “third type (or mode) information” indicates a 3GPP link (such as a sidelink, PC5), the second network node adds header information (such as an SRAP header) to the data packet, the added information may include the identification information of the bearer and/or the identification information of the user to which the data packet belongs, and the added information helps the second node to determine which first node to send the data packet to. If the above “third type (or mode) information” indicates a non-3GPP link (such as an ideal UE-UE link, a Proprietary link, WIFI), the second network node does not add an SRAP header to the data packet, and in order to enable the second node to distinguish different data, the second network node sends the data packet to the second node through the Uu RLC channel to which the data packet belongs or the logical channel to which the data packet belongs. In another embodiment, the second network node adds the identification information of the bearer and/or the identification information of the user to which the data packet belongs in the protocol layer header (such as a RLC layer and a MAC layer) of the data packet, and the added information helps the second node to determine which first node to send the data packet to.

The data targeted by the above two behaviours may be the data received by the second network node and belonging to the first node. Specifically, when the data is from the second node, the second network node may decide whether the data belongs to the first node according to the channel or logical channel carrying the data. In an example, the second network node thinks that the data carried by the Uu RLC channel belongs to the first node, and in another example, the second network node thinks that the data carried by a specific configured channel or logical channel belongs to the first node. The channel or logical channel carrying the data of the first node may be indicated by the first network node (as indicated by step 1-1a) or configured by the second network node (as configured by step 1-1b). When the data is data received by the second network node from the first network node (or the user plane part of the base station to which the first network node belongs), the second network node may decide whether the data belongs to the first node according to the tunnel carrying the data (such as the tunnel specified in step 1-1a) or the signaling (the setting of the network connection used to transmit the signaling of the first node (such as IP address and port number) is different from the setting of the network connection used to transmit the signaling of the second node, and the setting is configured when the first node accesses or uses the network), the data of the first node and the second node will adopts different channels or logical channels for transmission, and the channels adopted by the data may be indicated in the above step 1-1a or configured in the following step 1-1b.

Optionally, after the second network node receives the second configuration message, the second network node generates information for configuring the first node or the second node, and further includes step 1-1b: the second network node sends a second configuration response message to the first network node, the message is used to transmit the configuration information of the second node or the first node, and the configuration information may be used for configuring the second node or the first node (such as the configuration in step 1-2 above). The message includes at least one of the following information:
eighth identification indication information, which indicates the second node to which the first node needs to connect, and the information includes at least one of the following information:
identification information of the second node on the direct path, such as C-RNTI, C-RNTT and cell identification information;
an identification assigned to the second node on the first link (such as an identification assigned by the non-3GPP technology, such as a non-3GPP ID), in an implementation, the identification is assigned by the second node, and in another implementation, the identification is assigned by the first node;
an identification (such as a non-3GPP ID) used on the first link assigned by the first network node for the second node;
cell identification information, which indicates the cell accessed by the second node.
ninth identification indication information, which indicates the first node to which the second node needs to connect, and the information includes at least one of the following information:
identification information of the first node on the direct path, such as C-RNTI, C-RNTI and cell identification information;
an identification assigned to the first node on the first link (such as an identification assigned by the non-3GPP technology, such as a non-3GPP ID), in an implementation, the identification is assigned by the second node, and in another implementation, the identification is assigned by the first node;
an identification (such as a non-3GPP ID) used on the first link assigned by the first network node for the second node;
cell identification information, which indicates the cell accessed by the second node.
sixth type (or mode) information, which indicates the type (or mode) of the first link between the first node and the second node indicated by the above “eighth identification indication information” or the type (or mode) of the first link between the second node and the first node indicated by the above “ninth identification indication information”. The information may indicate at least one of the following types (or modes): a 3GPP link, a sidelink, a PC5 link, a link supporting a first scenario (a scenario where the first link adopts the 3GPP technology), a non-3GPP link, an ideal UE-UE link, a Proprietary link, a WIFI link and a link supporting a second scenario (a scenario where the first link adopts the non-3GPP technology). The information may help the first node and the second node to establish a connection.
third channel indication information, which indicates the channel used to send the data of the first node. In an embodiment, the channel is a channel between the second node and the first network node or the second network node. If the first node receives the information, the first node determines the channels or resources used for the receiving and sending of the data on the first link according to the information. If the second node receives the information, the second node determines whether the data packet received through the channel indicated by the information needs to be sent to the first node according to the information, the information includes at least one of the following information:
channel identification information, which identifies a channel for data transmission
logical channel identification information, which identifies a logical channel for user data transmission
indication information of channel data, which indicates whether the data on the channel is the data of the second node, or whether it is data needs to be relayed, or whether it is the data of the first node. If the second node receives the information, it may determine whether to forward the downlink data on the channel indicated by the above “channel identification information” or “logical channel identification information” to the first node, or whether to send the uplink data of the first node with the channel indicated by the above “channel identification information” or “logical channel identification information”
channel list information, the channel included in this information is a channel that carries the data of the first node or a channel that carries only the data of the second node. This information may identify a channel with at least one of the above “channel identification information” and “logical channel identification information”.

In order to help the first user equipment to measure the first link, optionally, before step 1-1, a process of configuring the first user equipment by the first network node is further included:

Step 1-0: The first network node sends a third configuration message to the first user equipment, the message is used to configure the first user equipment to discover and/or measure the nodes on the first link. The message includes at least one of the following information:
first threshold information, which indicates the threshold information used by the first user equipment to determine the candidate second user equipment which the first link may be established with, such as the threshold that PER needs to be lower than, the threshold that PDB needs to be lower than, the threshold that throughput needs to be higher than, etc. In an embodiment, the threshold indicated by the threshold information is the threshold that is required for the above “certain conditions”;
first number information, which indicates the maximum number of candidate second user equipment that the first user equipment determines the first link may be established with. In an embodiment, the number indicated by the number information is the number required for the above “certain number”;
first indication information, which is used to indicate the information of the first node, the information may help the first user equipment (that is, the second node) to know the information of the first node that needs to be measured, and after receiving the information, the first user equipment finds the first node on the first link or establish a connection with the first node. In an embodiment, the first node indicated by the information is the node that only supports establishing the first link through the non-3GPP technology (such as an ideal UE-UE link, a Proprietary link, WIFI), in another embodiment, the first node indicated by the information is the node that only supports establishing the first link through the 3GPP technology (such as a sidelink, PC5), and in another embodiment, the first node indicated by the information supports both establishing the first link through the non-3GPP technology (such as an ideal UE-UE link, a proprietary link, WiFi) and establishing the first link through the 3GPP technology (such as a sidelink, PC5), and the information includes at least one of the following information:
sixth identification indication information, which indicates the identification of the first node. In an embodiment, the information may also be used to inform the second node about the identification information of the first node. The information includes at least one of the following information:
identification information of the first node on the direct path, such as C-RNTI, C-RNTI and cell identification information;
an identification assigned to the first node on the first link (such as an identification assigned by the non-3GPP technology, such as a non-3GPP ID), in an implementation, the identification is assigned by the second node, and in another implementation, the identification is assigned by the first node. In an example, the information may be sent by the first node to the first network node before step 1-0, when the identification is assigned by the second node, the information may be sent by the second node to the first node through the first link, and then be informed by the first node to the first network node, or be informed by the second node to the first network node, and then be informed by the first network node to the first node before step 1-0, and in another example, the information may be sent by the second node to the first network node before step 1-0, when the identification is assigned by the first node, the information may be informed by the first node to the second node through the first link, and then be informed by the second node to the first network node before step 1-0, or be informed directly by the first node to the first network node;
an identification (such as a non-3GPP ID) used on the first link assigned by the first network node for the first node;
cell identification information, which indicates the cell accessed by the first node, such as the cell accessed by the first node on the direct path;
fourth type (or mode) information, which indicates the type (or mode) of establishing the first link supported by the first node, the information may indicate at least one of the following types (or modes), such as a 3GPP link (sidelink, PC5 link) and a non-3GPP link (ideal UE-UE link, Proprietary link).
first bearer information, which indicates the bearer required by the first node, the information may help the first user equipment (the second node) to know whether relay services may be provided for the first node. After receiving the information, the second node may determine the serviceable bearer according to its available air interface resources (such as the number of Uu RLC channels and the number of logical channels), and the information includes at least one of the following information:
second number information, which indicates the number of bearers of the first node;
identification information of the first bearer;
first QoS information, which may be the QoS that needs to be satisfied on the link between the first node and the first network node, and/or the QoS that the first node obtains on the first link, and/or the QoS that the first node needs to satisfy on the second link;
second indication information, which is used to indicate the information of the second node, the information may help the first user equipment (that is, the first node) to know the information of the second node that needs to be measured, and after receiving the information, the first user equipment finds the second node on the first link or establish a connection with the second node. In an embodiment, the second node indicated by the information is the node that only supports establishing the first link through the non-3GPP technology (such as an ideal UE-UE link, a Proprietary link, WIFI), in another embodiment, the second node indicated by the information is the node that only supports establishing the first link through the 3GPP technology (such as a sidelink, PC5), and in another embodiment, the first node indicated by the information supports both establishing the first link through the non-3GPP technology (such as an ideal UE-UE link, a proprietary link, WiFi) and establishing the first link through the 3GPP technology (such as a sidelink, PC5), and the information includes at least one of the following information:
seventh identification indication information, which indicates the identification of the second node. In an embodiment, the information may also be used to inform the first node about the identification information of the second node. The information includes at least one of the following information:
identification information of the second node, such as C-RNTI, C-RNTI and cell identification information;
an identification assigned to the second node on the first link (such as an identification assigned by non-3GPP technology, such as a non-3GPP ID), in an implementation, the identification is assigned by the second node, and in another implementation, the identification is assigned by the first node. In an example, the information may be sent by the second node to the first network node before step 1-0, when the identification is assigned by the first node, the information may be sent by the first node to the second node through the first link, and then be informed by the second node to the first network node, or be informed by the first node to the first network node, and then be informed by the first network node to the second node before step 1-0, and in another example, the information may be sent by the first node to the first network node before step 1-0, when the identification is assigned by the second node, the information may be informed by the second node to the first node through the first link, and then be informed by the first node to the first network node before step 1-0, or be informed directly by the second node to the first network node;
an identification (such as a non-3GPP ID) used on the first link assigned by the first network node for the second node;
cell identification information, which indicates the cell accessed by the second node;
fourth access indication information, which indicates the information of other nodes that establish connections with the second node. In an embodiment, the information indicates whether a node has established a connection with the second node, and in another embodiment, the information indicates whether a node has established a connection with the second node through the non-3GPP technology (or the 3GPP technology); in an embodiment, the information indicates the information of the number of nodes that have established a connection with the second node and in another embodiment, the information indicates the information of the number of nodes that have established a connection with the second node through the non-3GPP technology (or the 3GPP technology);
fifth type (or mode) information, which indicates the type (or mode) of establishing the first link supported by the second node, the information may indicate at least one of the following types (or modes): a 3GPP link, a sidelink, a PC5 link, a link supporting the first scenario (where the first link adopts the 3GPP technology), a non-3GPP link, an ideal UE-UE link, a Proprietary link, a WIFI link, and a link supporting the second scenario (where the first link adopts the non-3GPP technology);
second bearer information, which indicates the bearer served by the second node, the information may help the first user equipment (the first node) to know whether relay services may be provided by the second node for the first node. After receiving the information, the first node may determine whether to access the second node according to the available air interface resources of the second node (such as the number of Uu RLC channels and the number of logical channels), and the information includes at least one of the following information:
third number information, which indicates the number of bearers of the second node, or the number of RLC channels used, or the number of logical channels used, or the number of available RLC channels, or the number of available logical channels;
identification information of the second bearer/RLC channel/logical channel;
second QoS information, which may be the QoS that the second node may provide for the first node on the second link and/or the QoS that the second node may provide for the first node on the first link;
third indication information, which indicates the user terminal and/or the relay terminal served by the first network node. The first node may determine the second node that may establish the first link with the first node after knowing the information, and the second node may determine the first node that may establish the first link with the second node after knowing the information. In an embodiment, the information may be sent by the first network node to the first user terminal by broadcasting. The information includes at least one of the following information:
first access indication information, which is used to indicate the type of the node that the first network node is allowed to access. In an embodiment, the information indicates the capability of the first network node, such as the capability to support the first user equipment access, and the indication information may indicate at least one of the following types that it supports: 1) only supports the 3GPP technology (only supports the first scenario, that is, the first link adopts the 3GPP technology), and the information is to indicate that the first network node only supports the node that establishes the first link through the 3GPP technology (such as PC5, sidelink), and 2) only supports the non-3GPP technology (only supports the second scenario, that is, the first link adopts the non-3GPP technology), and the information is to indicate that the first network node only supports the node that establishes the first link through the non-3GPP technology (such as an ideal UE-UE link, a Proprietary link, WIFI), and 3) supports both the 3GPP technology (supporting the first scenario) and the non-3GPP technology (supporting the second scenario), and the information is to indicate the first network node and the node that supports to established the first link through the 3GPP technology, and the node that also supports to establish the first link through the non-3GPP technology. After receiving the information, the first user terminal may determine whether it may measure other nodes through the first link or establish the first link with other nodes according to the technology supported by the first network node and used on the first link;
second access indication information, which is used to indicate the information of the relay terminal in the network. After receiving the information, the first user equipment (first node) may determine whether the relay terminal may be measured or whether the first link may be established with the relay terminal. In an implementation, the information indicates information of a candidate relay terminal. The information includes at least one of the following information:
first list information, which indicates the information, such as identification information, of the relay terminal supporting the establishment of the first link through the non-3GPP technology (or supporting the second scenario), and further, the relay terminal indicated by the information may be the relay terminal that has not established the first link with other nodes;
second list information, which indicates the information, such as identification information, of the relay terminal supporting the establishment of the first link through the 3GPP technology (or supporting the first scenario);
third list information, which indicates the information, such as identification information, of the relay terminal supporting the establishment of the first link through both the 3GPP technology (or supporting the first scenario) and the non-3GPP technology (or supporting the second scenario).
third access indication information, which is used to indicate the information of the user terminal (remote UE) in the network, and after receiving the information, the first user equipment (second node) may determine whether the user terminal may be measured or whether the first link may be established with the user terminal. In an implementation, the information indicates information of the candidate user terminal. The information includes at least one of the following information:
fourth list information, which indicates the information, such as identification information, of the user terminal supporting the establishment of the first link through the non-3GPP technology (or supporting the second scenario), and further, the user terminal indicated by the information may be the user terminal that has not established the first link with other nodes;
fifth list information, which indicates the information, such as identification information, of the user terminal supporting the establishment of the first link through the 3GPP technology (or supporting the first scenario);
sixth list information, which indicates information, such as identification information, of the user terminal supporting the establishment of the first link through both the 3GPP technology (or supporting the first scenario) and the non-3GPP technology (or supporting the second scenario).

In order to help the first network node to know the user's capability, before step 1-1, the above method may further include a process of the first user equipment informing the first network node. For example, the following step is included:

Step 1-0a: the first user equipment sends a second notification message to the first network node, and the message is to inform the access type supported by the first user equipment, and after receiving the message, the first network node may configure nodes for establishing the first link for other users according to the capability of the first user equipment. The message may indicate the following access types supported by the first user equipment through at least one of the following information:
first equipment type information, which may indicate at least one of the following equipment types: 1) remote UE, which indicates that the first user equipment may communicate with the network through the indirect path, 2) a relay terminal, which indicates that the first user equipment may only serve as the relay terminal of other nodes and cannot access the network by itself through other relay terminals; 3) a user terminal and relay terminal, which indicates that the first user equipment may not only be used as the user terminal accessed through the relay terminal, but also provide relay services for other users;
first access type information, which may indicate the type of the first link established by the first user equipment, and the information may indicate at least one of the following types (or modes), such as a 3GPP link, a sidelink, a PC5 link, a link supporting the first scenario (where the first link adopts the 3GPP technology), a non-3GPP link, an ideal UE-UE link, a Proprietary link, a link, and a link supporting the second scenario (where the first link adopts the non-3GPP technology).
tenth identification indication information, which indicates the indication of the second node, and the information includes at least one of the following information:
identification information of the second node on the direct path, such as C-RNTI, C-RNTI and cell identification information;
an indication assigned to the second node on the first link (such as an indication assigned by the non-3GPP technology, such as a non-3GPP ID), in an implementation, the indication is assigned by the second node, and in another implementation, the indication is assigned by the first node;
an indication (such as a non-3GPP ID) used on the first link assigned by the first network node for the second node;
cell identification information, which indicates the cell accessed by the second node.
eleventh identification indication information, which indicates the indication of the first node, and the information includes at least one of the following information:
identification information of the first node on the direct path, such as C-RNTI, C-RNTI and cell identification information;
an indication assigned to the first node on the first link (such as an indication assigned by non-3GPP technology, such as a non-3GPP ID), in an implementation, the indication is assigned by the second node, and in another implementation, the indication is assigned by the first node;
an indication (such as a non-3GPP ID) used on the first link assigned by the first network node for the first node;
cell identification information, which indicates the cell accessed by the first node, such as the cell accessed by the first node on the direct path.

After the indirect path of the first node is established through the above process, if the first link is established by non-3GPP technology, the transmission method for the data of the first node on the second link includes at least one of the followings:
an uplink data: the second node adds the identification information and/or bearer identification information of the first node in the RLC packet header or the MAC packet header to send the data from the second node to the first network node.
a downlink data: the first network node or the second network node adds the identification information and/or bearer identification information of the first node in the RLC packet header or the MAC packet header to send the data to the second node.

In addition, the above messages may have various specific implementations, and only some of them are illustrated below, but it may be understood that the invention is not limited herein.

The above first notification message may be a measurement report message, or another RRC message or a newly defined RRC message.

The above first configuration message/third configuration message may be a RRCre-configuration message, a broadcast message (such as SIB), another RRC message or a newly defined RRC message.

The above second configuration message may be a message of a UE context setup/modification request of an F1 interface, another F1 interface message or a message of newly defined F1 interface.

The above second configuration response message may be a message of a UE context setup/modification response of an F1 interface, another F1 interface message or a message of newly defined F1 interface.

The above second notification message may be a RRCReconfigurationComplete message, a RRCSetupComplete/RRCReestablishmentComplete/RRCResumeComplete message, a UE capability information message, another RRC message or a newly defined RRC message.

Usage of the above processes of the invention will be explained by different embodiments.

An embodiment regarding the selection of the first link access type is described below.

In the implementation, it is to help determine the type of the first link established by the first node or the second node. In the implementation, the first network node determines the added indirect path according to the type of the first link reported by the first user equipment.

Step a-1: the first user equipment (the first node or the second node) sends the first notification message to the first network node (as above step 1-1), the message may include the indication of the first node or the second node (such as the above “first identification indication information”), measurement information (such as the above “first measurement indication information” or “second measurement indication information”, the information may indicate the type of the measured first link).

Step a-2: the first network node sends the first configuration message to the first node (above step 1-2), the message may indicate the second node on the first link (such as the above “second identification indication information”) or the access type used on the first link (such as the above “second type (or mode) information”).

In an alternative embodiment, step a-1 may further include:

Step a-1a: the first network node configures the measurement of the first user equipment (the first node or the second node), as above step 1-0, in which the first network node may indicate the measured candidate node (such as the above “first indication information”, “second indication information” or “third indication information”).

Further, step a-0 is included before step a-1a: the first user equipment (first node or second node) informs the first network node of the type of the first link it supports, as above step 1-0a, and the information may help the first network node to generate the configuration in step a-1a.

Optionally, step a-Ga may be included before step a-0: the first network node broadcasts the type of the first link it supports, as above step 1-0 (the above “third indication information”).

In another alternative embodiment, the following is further included before step a-1:

Step a-1b: the second node informs the first node of the type of the first link it supports through the first link.

An embodiment regarding the configuration of the candidate second node is described below.

In the implementation, in order to help the first node to find the second node that may establish the first link with, the network configures the candidate second node for the first node. The process includes the following steps:

Step b-1: the first network node sends a message to the first node (as above step 1-0), the message includes the information of the candidate second node (such as the above “second indication information” or “third indication information”);

In an alternative embodiment, the following may be further included before step b-1:

Step b-0: the second node sends the information of the candidate first node to the first network node, as above step 1-1.

An embodiment regarding the indication of the first node and the second node is described below.

In the implementation, when the first link is established by non-3GPP technology, it is necessary to correctly identify the first node and the second node, so that the relationship between the first node and the second node may be guaranteed in the configuration process. In the implementation, there are different embodiments according to the indication of the adopted identification node. The following is only explained by several different embodiments, but it may be understood that the invention is not limited herein, and any of the above methods for indicating nodes or any combination thereof belong to the scope of protection of the invention.

Embodiment 1: the first node indicates the second node with the C-RNTI+(optional, a cell identification) of the second node.

The first node sends the C-RNTI+(optional, a cell identification) of the second node to the first network node (such as the message used in above step 1-1 or 1-0a), and then the first network node configures the first link between the first node and the second node.

In an implementation, the first node may obtain the above C-RNTI+(optional, a cell identification) through the first link.

In another implementation, the first node may obtain the above C-RNTI+(optional, a cell identification) through the first network node (such as the message used in the above step 1-2 or 1-0), and indicate the second node with the above C-RNTI+(optional, a cell identification) on the first link.

In another implementation, the first network node informs the first node of the non-3GPP ID (which may be unique) of the second node, and informs the first node of the above C-RNTI+(optional, a cell identification) of the second node (such as the message used in the above step 1-2 or 1-0). In this way, the first node may identify the second node on the first link with the non-3GPP ID. When the second node is detected or found, the first node may inform the first network node of the above C-RNTI+(optional, a cell identification) corresponding to the non-3GPP ID (such as the message used in the above step 1-1 or 1-0a), and further, the first network node may also inform the second node of its assigned non-3GPP ID (such as the message used in the above step 1-2 or 1-0).

In another implementation, the second node is indicated by the non-3GPP ID (which is not unique, but is assigned by the first node or the second node on the first link)+C-RNTI+(optional, a cell identification), and the first network node needs to inform the first node of the non-3GPP ID (which is not unique)+C-RNTI+(optional, a cell identification) of the second node (such as the message used in above step 1-2 or 1-0), and meanwhile, the second node needs to inform the first network node of its non-3GPP ID (such as the message used in above step 1-1 or 1-0a).

Embodiment 2: the first node indicates the second node with the non-3GPP ID (unique ID) of the second node.

In the implementation, the first node informs the first network node of the measured or detected second node through the non-3GPP ID (unique ID) of the second node.

In an implementation, the second node may inform the first node of its non-3GPP ID through the first link.

In another implementation, the second node may inform the first node of its non-3GPP ID through the first link, and meanwhile, the first network node informs the first node about the non-3GPP ID of the second node (such as the message used in above step 1-2 or 1-0), and also informs the second node of its non-3GPP ID assigned by the first network node (such as the message used in above step 1-2 or 1-0).

Embodiment 3: the first node indicates the second node with the non-3GPP ID (a non-unique ID)+C-RNTI+(optional, a cell identification) of the second node.

In the implementation, the first node informs the first network node of the measured or detected second node through the non-3GPP ID (a non-unique ID)+C-RNTI+(optional, a cell identification) of the second node.

In an implementation, the second node may inform the first node of its non-3GPP ID (a non-unique ID)+C-RNTI+(optional, a cell identification) through the first link.

In another implementation, the second node may inform the first node of its non-3GPP ID (a non-unique ID)+C-RNTI+(optional, a cell identification) through the first link, and meanwhile, the first network node informs the first node about the non-3GPP ID (a non-unique ID)+C-RNTI+(optional, a cell identification) of the second node (such as the message used in above step 1-2 or 1-0), the second node also informs the first network node of its non-3GPP ID (non-unique ID) (such as the message used in above step 1-1 or 1-0a).

Embodiment 4: the second node indicates the first node with the C-RNTI+(optional, a cell identification) of the first node.

The second node sends the C-RNTI+(optional, a cell identification) of the first node to the first network node (such as the message used in above step 1-1 or 1-0a), and then the first network node configures the first link between the first node and the second node.

In an implementation, the second node may obtain the above C-RNTI+(optional, a cell identification) through the first link.

In another implementation, the second node may obtain the above C-RNTI+(optional, a cell identification) through the first network node (such as the message used in the above step 1-2 or 1-0), and indicate the first node with the above C-RNTI+(optional, a cell identification) on the first link.

In another implementation, the first network node informs the second node of the non-3GPP ID (which may be unique) of the first node (such as the message used in the above step 1-2 or 1-0) and informs the second node of the above C-RNTI+(optionally, the cell identification) of the first node (such as the message used in the above step 1-2 or 1-0). In this way, the second node may identify the first node on the first link with the non-3GPP ID. When the first node is detected or found, the second node may inform the first network node of the above C-RNTI+(optional, cell identification) corresponding to the non-3GPP ID (such as the message used in the above step 1-1 or 1-Ga), and further, the first network node may also inform the first node of the non-3GPP ID assigned to the first node (such as the message used in the above step 1-2 or 1-0)

In another implementation, the first node is indicated by the non-3GPP ID (which is not unique, but is assigned by the first node or the second node on the first link)+C-RNTI+(optional, a cell identification), and the first network node needs to inform the second node of the non-3GPP ID (which is not unique)+C-RNTI+(optional, a cell identification) of the first node (such as the message used in above step 1-2 or 1-0), and meanwhile, the first node needs to inform the first network node of its non-3GPP ID (such as the message used in step 1-1 or 1-0a above).

Embodiment 5: the second node indicates the first node with the non-3GPP ID (a unique ID) of the first node.

In the implementation, the second node informs the first network node of its measured or detected first node through the non-3GPP ID (a unique ID) of the first node.

In an implementation, the first node may inform the second node of its non-3GPP ID through the first link.

In another implementation, the first node may inform the second node of its non-3GPP ID through the first link, and meanwhile, the first network node informs the second node about the non-3GPP ID of the first node (such as the message used in the above step 1-2 or 1-0), and also informs the first node of the non-3GPP ID of the first node assigned by the first network node (such as the message used in the above step 1-2 or 1-0).

Embodiment 6: the second node indicates the first node with the non-3GPP ID (a non-unique ID)+C-RNTI+(optional, a cell identification) of the first node.

In the implementation, the second node informs the first network node of its measured or detected first node through the non-3GPP ID (a non-unique ID)+C-RNTI+(optional, a cell identification) of the first node.

In an implementation, the first node may inform the second node of its non-3GPP ID (non-unique ID)+C-RNTI+(optional, cell identification) through the first link.

In another implementation, the first node may inform the second node of its non-3GPP ID (a non-unique ID)+C-RNTI+(optional, a cell identification) through the first link, and meanwhile, the first network node informs the second node about the non-3GPP ID (a non-unique ID)+C-RNTI+(optional, a cell identification) of first node (such as the message used in above step 1-2 or 1-0), the first node also informs the first network node of its non-3GPP ID (non-unique ID) (such as the message used in step 1-1 or 1-Ga above).

Embodiment 7: situation regarding a plurality of first nodes being connected to one second node.

In the embodiment, in order to illustrate the relationship between the first node and the second node, the first node or the second node may inform the first network node through the identification pair of nodes, such as {the non-3GPP ID of the first node, the non-3GPP ID of the second node} and {the C-RNTI+(optionally, the cell identification) of the first node, the C-RNTI+(optionally, the cell identification) of the second node}(such as the message used in the above step 1-1 or 1-0a).

FIG. 7 is a block diagram illustrating the structure of first user equipment 400 according to an embodiment of the disclosure.

Referring to FIG. 7, the first user equipment 400 includes a transceiver 401 and a processor 402. The transceiver 401 is configured to transmit and receive signals to and from the outside. The processor 402 is configured to perform the above-described methods performed by the first user equipment. The first user equipment 400 may be implemented in the form of hardware, software or a combination of hardware and software, so that it may perform the methods performed by the first user equipment described in the disclosure.

The structure of FIG. 7 may correspond to a structure of second user equipment.

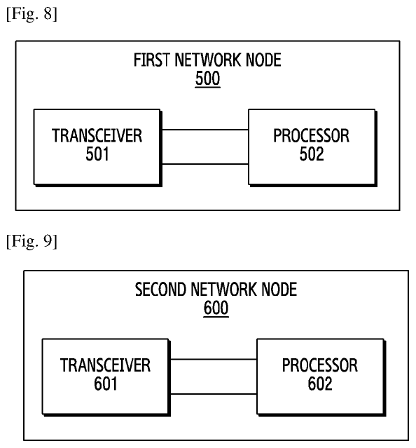

FIG. 8 is a block diagram illustrating the structure of a first network node 500 according to an embodiment of the disclosure.

Referring to FIG. 8, the first network node 500 includes a transceiver 501 and a processor 502. The transceiver 501 is configured to transmit and receive signals to and from the outside. The processor 502 is configured to perform the methods performed by the first network node. The first network node 500 may be implemented in the form of hardware, software or a combination of hardware and software, so that it may perform the methods performed by the first network node described in the disclosure.

FIG. 9 is a block diagram illustrating the structure of a second network node 600 according to an embodiment of the disclosure.

Referring to FIG. 9, the second network node 600 includes a transceiver 601 and a processor 602. The transceiver 601 is configured to transmit and receive signals to and from the outside. The processor 602 is configured to perform the methods performed by the second network node. The second network node 600 may be implemented in the form of hardware, software or a combination of hardware and software, so that it may perform the methods performed by the second network node described in the disclosure.

In one embodiment, a method performed by first user equipment, the method comprising: sending a first message to a first network node, the first message is used for informing information related to a type or mode of a first link; receiving a second message sent by the first network node, the second message is used for configuring the first user equipment to perform data transmission with the first network node through the first link between the first user equipment and a second user equipment;

In one embodiment, the method further comprising: establishing the first link with the second user equipment.

In one embodiment, wherein the first message comprises at least one of the followings: first identification indication information for indicating identification information of the first user equipment and/or the second user equipment; first measurement indication information for indicating a measurement result of the first user equipment; or second measurement indication information for indicating a measurement result of the second user equipment.

In one embodiment, wherein the first identification indication information comprises at least one of the followings: first identification information including identification information of the first user equipment; second identification information including identification information of the second user equipment; or third identification information including an identification pair of an identification of the first user equipment and an identification of the second user equipment.

In one embodiment, wherein the first measurement indication information or the second measurement indication information comprises at least one of the followings: association identification information for indicating the measured first user equipment or the second user equipment; measurement result information for indicating a measurement result of the first link by the first user equipment or the second user equipment; or first type or mode information for indicating a type or mode of the first link.

In one embodiment, wherein the measurement result information comprises at least one of the followings: signal strength information; indication information of a signal quality or link quality for indicating a quality of the first link; parameter information of an obtainable quality of service (QoS) for indicating a quality of service that the first user equipment is able to reach on the first link; or priority indication information for indicating a priority of the second user equipment or the first user equipment.

In one embodiment, wherein the first measurement indication information or the second measurement indication information comprises a list composed of at least an association identification information and/or the measurement result information corresponding to the at least an association identification information.

In one embodiment, wherein the priority is determined based on a position of the association identification information corresponding to the user equipment in the association identification information list in the measurement indication information.

In one embodiment, wherein the second message comprises at least one of the followings: first user equipment identification; a second user equipment identification; or a type or mode of the first link.

In one embodiment, wherein the type of the first link comprises at least one of the followings: a 3rd generation partnership project (3GPP) link; or a non-3GPP link.

In one embodiment, the method further comprising: sending a fourth message to the first network node, the fourth message is used for informing an access type or mode supported by the first user equipment.

In one embodiment, wherein the access type or mode comprises at least one of the followings: 3rd generation partnership project (3GPP); or non-3GPP.

In one embodiment, wherein the fourth message comprises at least one of the followings: first equipment type information, wherein the first equipment type information is at least one of the followings: remote user equipment or relay user equipment; first access type or mode information for indicating a type or mode of the first link.

In one embodiment, wherein the first identification information, the second identification information, the association identification information, the first user equipment identification and the second user equipment identification comprise at least one of the followings: identification information on a direct path; a first identification related to the first link; a second identification related to the first link; or cell identification information.

In one embodiment, wherein, the first user equipment is a first node or a second node, and the second user equipment is the first node or the second node, wherein the first node is a node that performs data transmission with the first network node through a relay node on the first link, and the second node is a relay node connected with the first network node on the first link.

In one embodiment, A method performed by a first network node, the method comprising: receiving a first message sent by first user equipment, the first message is used for informing information related to a type or mode of a first link; sending a second message to the first user equipment, the second message is used for configuring the first user equipment to perform data transmission with the first network node through the first link between the first user equipment and a second user equipment.

In one embodiment, A method performed by a second network node, the method comprising: receiving a third message sent by the first network node, the third message is used for requesting the second network node to configure first user equipment and/or a second user equipment; receiving data sent by the second user equipment or a first network equipment, and processing the received data based on the third message. At least an embodiment of the disclosure also provides a non-transitory computer-readable recording medium, on which a program for executing the above methods when run by a computer has been stored.

Various embodiments of the disclosure may be implemented as computer-readable codes embodied on a computer-readable recording medium from a specific perspective. The computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (for example, data transmission via the Internet), and the like. Computer-readable recording media can be distributed through computer systems connected via a network, and thus computer-readable codes can be stored and executed in a distributed manner. Moreover, functional programs, codes and code segments for implementing various embodiments of the disclosure can be easily interpreted by those skilled in the art to which the embodiments of the disclosure are applied.

It will be understood that the embodiments of the disclosure can be implemented in the form of hardware, software, or a combination of hardware and software. Software can be stored as program instructions or computer-readable code executable on a processor on a non-transitory computer-readable medium. Examples of non-transitory computer-readable recording media include magnetic storage media (e.g., ROM, floppy disk, hard disk, etc.) and optical recording media (e.g., CD-ROM, digital video disk (DVD), etc.). Non-transitory computer-readable recording media can also be distributed on network-coupled computer systems, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program (s) having instructions for implementing embodiments of the disclosure. The disclosure can be realized by a program having codes for concretely implementing the apparatus and method described in the claims, which is stored in a machine (or computer) readable storage medium. The program may be electronically carried on any medium, such as a communication signal transmitted via a wired or wireless connection, and this disclosure suitably includes its equivalents.

What has been described above is only the specific implementation of this disclosure, but the protection scope of this disclosure is not limited to this. Any person familiar with this technical field can make various changes or substitutions within the technical scope disclosed in this disclosure, and these changes or substitutions should be included in the protection scope of this disclosure. Therefore, the scope of protection of this disclosure should be based on the scope of protection of the claims.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a base station in a wireless communication system, the method comprising:
receiving, from a remote user equipment (UE) via a direct path, a first message including information on a relay UE, wherein the remote UE is connected to the relay UE via a non-3^{rd} Generation Partnership Project (3GPP) link;
transmitting, to the remote UE, a second message including first configuration information for an indirect path between the remote UE and the base station via the relay UE;
receiving, from the remote UE via the indirect path, uplink data.

2. The method of claim 1,
wherein the information on the relay UE includes a Cell-Radio Network Temporary Identifier (C-RNTI) and cell identification information on the relay UE.

3. The method of claim 1, wherein the base station does not use a sidelink relay adaptation protocol (SRAP) layer for data received from the remote UE via the relay UE.

4. The method of claim 1,
wherein the first configuration information for the indirect path includes identification information of a channel for the relay UE.

5. A method performed by a remote user equipment (UE) in a wireless communication system, the method comprising:
transmitting, to a base station via a direct path, a first message including information on a relay UE, wherein the remote UE is connected to the relay UE via a non-3^{rd} Generation Partnership Project (3GPP) link;
receiving, from the base station, a second message including first configuration information for an indirect path between the remote UE and the base station via the relay UE;
transmitting, to the base station via the indirect path, uplink data.

6. The method of claim 5,
wherein the information on the relay UE includes a Cell-Radio Network Temporary Identifier (C-RNTI) and cell identification information on the relay UE.

7. The method of claim 5,
wherein the base station does not use a sidelink relay adaptation protocol (SRAP) layer for data received from the remote UE via the relay UE.

8. The method of claim 5
wherein the first configuration information for the indirect path includes identification information of a channel for the relay UE.

9. A base station in a wireless communication system, the base station comprises:
a transceiver; and
a processor couple to the transceiver;
wherein the processor configured to:
receive, from a remote user equipment (UE) via a direct path, a first message including information on a relay UE, wherein the remote UE is connected to the relay UE via a non-3^{rd} Generation Partnership Project (3GPP) link;
transmit, to the remote UE, a first message including first configuration information for an indirect path between the remote UE and the base station via the relay UE;
receive, from the remote UE via the indirect path, uplink data.

10. The base station of claim 9,
wherein the information on the relay UE includes a Cell-Radio Network Temporary Identifier (C-RNTI) and cell identification information on the relay UE.

11. The base station of claim 9,
wherein the base station does not use a sidelink relay adaptation protocol (SRAP) layer for data received from the remote UE via the relay UE.

12. The base station of claim 9,
wherein the first configuration information for the indirect path includes identification information of a channel for the relay UE.

13. A remote user equipment (UE) in a wireless communication system, the remote UE comprises:
a transceiver; and
a processor couple to the transceiver;
wherein the processor configured to:
transmit, to a base station via a direct path, a first message including information on a relay UE, wherein the remote UE is connected to the relay UE via a non-3^{rd} Generation Partnership Project (3GPP) link;
receive, from the base station, a second message including first configuration information for an indirect path between the remote UE and the base station via the relay UE;
transmit, to the base station via the indirect path, uplink data.

14. The remote UE of claim 13,
wherein the information on the relay UE includes a Cell-Radio Network Temporary Identifier (C-RNTI) and cell identification information on the relay UE, and
wherein the base station does not use a sidelink relay adaptation protocol (SRAP) layer for data received from the remote UE via the relay UE.

15. The remote UE of claim 13,
wherein the first configuration information for the indirect path includes identification information of a channel for the relay UE.
